(19) United States
(12) Patent Application Publication
(10) Pub. No.: US 2016/0159416 A1
(43) Pub. Date: Jun. 9, 2016

(54) SHOCK ABSORBER FOR CRAWLER

(71) Applicant: CATERPILLAR SARL, Geneva (CH)

(72) Inventors: Joji OKAMOTO, Tokyo (JP); Keisuke KIMURA, Hyogo (JP)

(73) Assignee: Caterpillar SARL, Geneva (CH)

(21) Appl. No.: 14/905,049

(22) PCT Filed: Jul. 18, 2014
(86) PCT No.: PCT/EP2014/065521

§ 371 Date: Jan. 14, 2016

(30) Foreign Application Priority Data
Jul. 19, 2013 (JP) 2013-150922

(51) Int. Cl. B62D 55/108; B62D 55/06; F16F 1/12

(52) U.S. Cl. CPC B62D 55/108; F16F 1/121; B62D 55/06

(57) ABSTRACT

A shock absorber for a crawler is disclosed. The shock absorber may have a coil spring to bias an idler wheel from a frame of the crawler. The shock absorber may also have an adjustment cylinder to adjust a bias force of the coil spring. The adjustment cylinder may have a flange projecting radially outward. The shock absorber may have a support member disposed circumferentially around at least a portion of the adjustment cylinder. The support member may have a spring bearing portion projecting radially outward. The shock absorber may have a retaining plate projecting radially from the adjustment cylinder. The retaining plate may be configured to prevent axial separation of the adjustment cylinder and the support member. The coil spring may be positioned on an outer peripheral side of the adjustment cylinder and the support member and disposed in abutting contact with the flange and the spring bearing portion.

### TECHNICAL FIELD

The present invention relates to a shock absorber for a crawler which is wound around a drive wheel and an idler wheel.

### BACKGROUND ART

In general, a hydraulic excavator, which is a typical example of a construction vehicle, generally includes a lower traveling body that can be self-propelled, an upper slewing body mounted on the lower traveling body so as to be able to slew, and a working arm apparatus mounted to the upper slewing body so as to be able to be raised and lowered.

The lower traveling body includes a base frame having a car body on which the upper slewing body is mounted so as to be able to slew and a pair of track frames extending in the horizontal direction so as to sandwich the car body between the track frames, a pair of drive wheels disposed on one end side of each of the track frames, a pair of idler wheels disposed on the other end side of each track frame, a pair of endless crawlers each wound around the drive wheel and the idler wheel, and a pair of shock absorbers for the crawlers which absorbs shocks applied to the crawlers.

For convenience of description, in the Description, a front side is defined as a side where each idler wheel is disposed, and a rear side is defined as a side where each driven wheel is disposed. A front-rear direction is defined as the direction of a line joining the idler wheel and drive wheel on one side together or the direction of a line joining the idler wheel and drive wheel on the other side together. A lateral direction is defined as the direction of a line joining the idler wheels or the drive wheels together.

The shock absorber for the crawler is an apparatus connected to the idler wheel to absorb a shock applied to the crawler via the idler wheel. The shock absorber for the crawler generally includes a coil spring which biases the crawler and absorbs a shock applied to the crawler, an adjustment cylinder that adjusts the bias force of the coil spring, and a support member that axially supports the idler wheel so that the idler wheel is rotatable.

The adjustment cylinder includes a tube positioned behind the idler wheel and extending in the front-rear direction, a flange projecting radially outward from an outer peripheral surface of the tube, and a rod extending forward from a front end portion of the tube.

The support member is disposed between the idler wheel and the adjustment cylinder. The support member generally includes an annular end surface wall into which a front end side of the rod of the adjustment cylinder is slidably inserted, a peripheral surface wall extending forward from an outer peripheral edge of the annular end surface wall, a spring bearing portion projecting radially outward from an outer peripheral surface of the peripheral surface wall, a lateral pair of projecting portions projecting laterally outward from an outer peripheral edge of the spring bearing portion, and a lateral pair of support portions extending forward from the projecting portions.

The idler wheel is disposed between the support portions. The support member axially supports the idler wheel in each of the support portions so that the idler wheel is rotatable. Furthermore, the support member is held by each track frame so as to be movable in the front-rear direction.

The coil spring is positioned on an outer peripheral side of the tube and rod of the adjustment cylinder and disposed such that axial ends of the coil spring are in abutting contact with the flange of the adjustment cylinder and the spring bearing portion of the support member. Furthermore, the coil spring is compressed between the flange and the spring bearing portion by a predetermined amount to store a predetermined amount of bias force in the coil spring.

An inner periphery of the annular end surface wall of the support member is shaped to conform to the rod of the adjustment cylinder. The front end side of the rod is inserted into the annular end surface wall along the inner periphery of the annular end wall to couple the adjustment cylinder and the support member together.

However, since the rod is slidably inserted into the inner periphery of the annular end surface wall, the adjustment cylinder and the support member can move relative to each other. Thus, a retaining mechanism is provided on the front end side of the rod to inhibit the rod from slipping out from the inner periphery of the annular end surface wall when the bias force of the coil spring presses the adjustment cylinder and the support member in a direction in which the adjustment cylinder and the support member are separated from each other.

The retaining mechanism includes an external thread portion formed on an outer peripheral surface of the front end side of the rod, a nut and a washer corresponding to the external thread portion, a pair of internal thread portions formed on an axially front end surface of the rod, a pair of bolts corresponding to the internal thread portions, and a locking plate having a pair of through-holes formed therein in association with the internal thread portions and bent at a right angle at opposite ends of the plate.

The nut and the washer are attached to the external thread portion of the rod, and then, the locking plate is installed on the nut so as to cover an outer periphery of the nut. Then, a pair of bolts passed through the pair of through-holes in the locking plate is attached to the internal thread portions of the rod. The washer and an inner surface of the annular end surface wall are brought into abutting contact with each other to inhibit the rod from slipping out from the inner periphery of the annular end surface wall.

In the shock absorber for the crawler configured as described above, when the crawler is shocked, the support member axially supporting the idler wheel moves from the front side toward the rear side along with the idler wheel. Then, the coil spring is compressed because the coil spring is in abutting contact with the spring bearing portion of the support member at the front end portion of the coil spring, and is restrained by the flange of the adjustment cylinder from moving in the front-rear direction, the flange of the adjustment cylinder being in abutting contact with a rear end portion of the coil spring. Thus, the shock applied to the crawler is absorbed. After the shock is absorbed, the coil spring extends to move the support member from the rear side toward the front side so as to return to the original position where the coil spring is located before being shocked. However, the coupling with the adjustment cylinder is held by the retaining mechanism (see, for example, Patent Document 1).
Patent Document 1: Japanese Patent Application Laid-Open No. 2006-199157

The conventional shock absorber for the crawler as described above has problems to be solved as follows.

When the hydraulic excavator is driven and operated on an irregular ground, the crawler is repeatedly severely shocked. Thus, the shock absorber for the crawler needs to repeatedly absorb the severe shock. Therefore, to absorb such repeated shocks, the coil spring repeats being compressed and extended many times.

As a result, a heavy load acts repeatedly on the retaining mechanism for the adjustment cylinder and the support member. That is, since the coil spring repeats being compressed and extended many times, the washer of the retaining mechanism and the inner surface of the annular end surface wall collide repeatedly against each other many times. The collisions cause severe stress to be repeatedly concentrated on threaded portions of the external thread portion of the rod and the nut, particularly the threaded portion at an end portion of the nut positioned on the washer side. Finally, a failure, that is, breakage of the threaded portions, may occur relatively early.

Furthermore, in the conventional shock absorber for the crawler, a fixed position of the nut in the front-rear direction is likely to vary among vehicles, and thus, the following often vary among vehicles: the position of the spring bearing portion of the support member in the front-rear direction, and further the position of the flange of the adjustment cylinder in the front-rear direction. Thus, when an operator mounts the shock absorber for the crawler on the vehicle and compresses the coil spring by a predetermined amount to store a predetermined amount of bias force in the coil spring, setting the amount of bias force within a predetermined range involves much effort and time.

With the foregoing in view, it is a main technical object of the present invention to provide a shock absorber for a crawler which enables a reduction in stress concentration on a retaining mechanism for an adjustment cylinder and a support member to prevent the retaining mechanism from being broken even if a severe load is repeatedly imposed on the retaining mechanism when, for example, a hydraulic excavator is driven and operated on an irregular ground.

It is another technical object of the present invention to provide a shock absorber for a crawler which allows the bias force of a coil spring to be set within a predetermined range when an operator mounts the shock absorber for the crawler on a vehicle and compresses the coil spring by a predetermined amount to store a predetermined amount of bias force in the coil spring.

### DISCLOSURE OF THE INVENTION

As the shock absorber for the crawler accomplishing the above-described objects, the present invention provides a shock absorber for a crawler including an endless crawler wound around a drive wheel and an idler wheel, a coil spring which biases the crawler and absorbs a shock applied to the crawler, an adjustment cylinder that adjusts a bias force of the coil spring, and a support member that axially supports the idler wheel so that the idler wheel is rotatable, wherein the adjustment cylinder includes a tube positioned behind the idler wheel and extending in a front-rear direction, a flange projecting radially outward from an outer peripheral surface of the tube and extending in a circumferential direction, and a cylindrical rod extending forward from a front end portion of the tube, the support member includes an annular end surface wall into which a front end side of the rod is slidably inserted, a peripheral surface wall extending forward from an outer peripheral edge of the annular end surface wall, and a spring bearing portion projecting radially outward from an outer peripheral surface of the peripheral surface wall and extending in the circumferential direction, the coil spring is positioned on an outer peripheral side of the tube and the rod and disposed in abutting contact with the flange and the spring bearing portion, and a recess portion is formed in an outer peripheral surface of the front end side of the rod, and a retaining plate projecting radially outward from the rod is disposed in the recess portion, such that the retaining plate and an inner surface of the annular end surface wall are in abutting contact with each other to inhibit the rod from slipping out from an inner periphery of the annular end surface wall.

The recess portion preferably extends in a circumferential direction along an outer peripheral surface of the rod. Preferably, the recess portion is shaped like a ring. The retaining plate preferably extends in the circumferential direction along the outer peripheral surface of the rod. Preferably, the retaining plate is shaped like a ring. The retaining plate is favorably formed of at least two semi-annular plate members into which a plate material shaped like a ring is divided. Preferably, an annular groove is formed in an outer peripheral surface of the retaining plate, and a retaining ring is installed in the annular groove such that the retaining plate is fixed in the recess portion by the retaining ring.

In the shock absorber for the crawler configured according to the present invention, even when a heavy load acts repeatedly on the retaining mechanism for the adjustment cylinder and the support member if, for example, the hydraulic excavator is driven and operated on an irregular ground, the load is received by a surface of the retaining plate and a surface of the recess portion formed in the rod. This enables a reduction in stress generated on the surface of the retaining plate and the surface of the recess portion compared to the stress generated in the threaded portions of the retaining mechanism in the conventional shock absorber for the crawler. Thus, the retaining mechanism according to the present invention can be prevented from being broken.

Furthermore, the recess portion can be formed in a predetermined position in the rod before the shock absorber for the crawler is mounted on the vehicle. This allows suppression of a variation in the position where the retaining plate is disposed in the front-rear direction. Hence, the bias force of the coil spring can be easily set within a predetermined range when an operator mounts the shock absorber for the crawler on the vehicle and compresses the coil spring by a predetermined amount to store a predetermined amount of bias force in the coil spring.

### BRIEF DESCRIPTION OF THE DRAWINGS

FIG. 1 is a top view of an important part of a shock absorber for a crawler configured according to the present invention.

FIG. 2 is a side view of the shock absorber for the crawler shown in FIG. 1.

FIG. 3 is a cross-sectional view of the shock absorber as seen in a direction A-A in FIG. 2.

FIG. 4 is a front view and a side view of a retaining plate.

FIG. 5 is a side view of a hydraulic excavator including the shock absorber for the crawler shown in FIG. 1.

### BEST MODE FOR CARRYING OUT THE INVENTION

A shock absorber for a crawler configured according to the present invention will be described below with reference to an embodiment shown in FIGS. 1 to 5 and in which the shock absorber is provided in a hydraulic excavator, which is a typical construction vehicle.

Description will be given with reference to FIG. 5. A hydraulic excavator generally shown by reference numeral 1 generally includes a lower traveling body 2 that can be self-propelled, an upper slewing body 3 mounted on the lower traveling body 2 so as to be able to slew, and a working arm apparatus 4 mounted to the upper slewing body 3 so as to be able to be raised and lowered.

The lower traveling body 2 has a base frame 7 providing a framed structure and generally including a car body 5 on which the upper slewing body 3 is mounted so as to be able to slew and a pair of track frames 6 extending in the horizontal direction so as to sandwich the car body 5 between the track frames 6.

Each of the track frames 6 includes a lateral pair of drive wheels 9 disposed on a rear end side and rotationally driven by a pair of hydraulic motors 8, a lateral pair of idler wheels 10 disposed on a front end side, a lateral pair of endless crawlers 11 each wound around the drive wheel 9 and the idler wheel 10, and a lateral pair of shock absorbers 12 for the crawlers configured to absorb shocks applied to the crawlers 11.

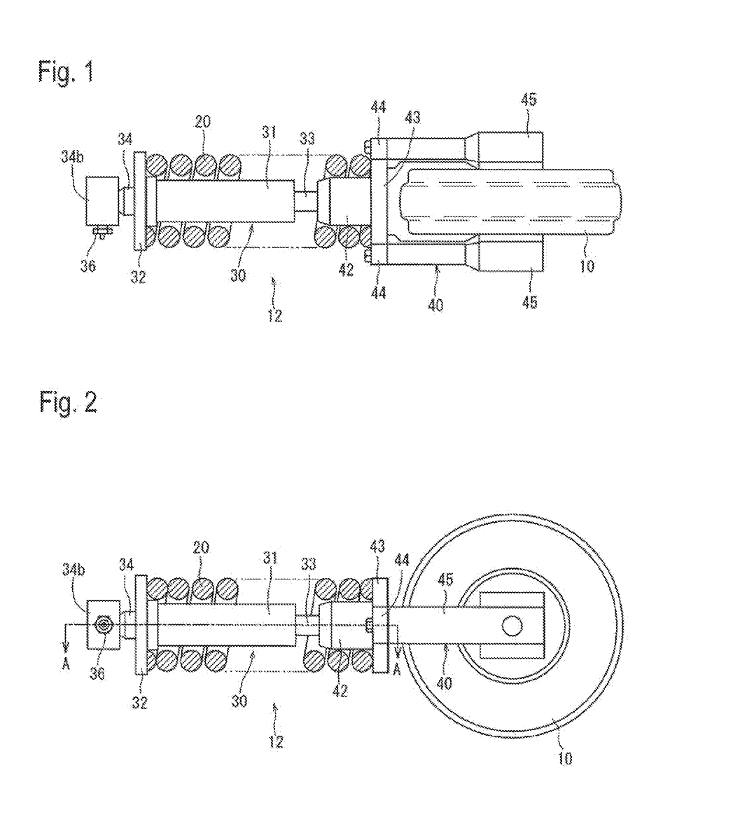

Description will be given with reference to FIG. 1 and FIG. 2. The shock absorber 12 for the crawler is an apparatus connected to the idler wheel 10 to absorb a shock applied to the crawler 11 via the idler wheel 10. The shock absorber 12 also has a function to adjust tension of the crawler 11. The shock absorber 12 for the crawler generally includes a coil spring 20 which biases the crawler 11 and which absorbs a shock applied to the crawler 11, an adjustment cylinder 30 that adjusts the bias force of the coil spring 20, and a support member 40 that axially supports the idler wheel 10 so that the idler wheel 10 is rotatable.

Description will be given with reference to FIG. 3 along with FIG. 1 and FIG. 2. The adjustment cylinder 30 generally includes a cylindrical tube 31 positioned behind the idler wheel 10 and extending in a front-rear direction, an annular flange 32 projecting radially outward from an outer peripheral surface of the tube 31 and extending in a circumferential direction, a cylindrical rod 33 extending forward from a front end portion of the tube 31, and a piston 34 shaped like a cylinder and having a front end side 34a slidably inserted into the tube 31 from a rear end side of the tube 31. The adjustment cylinder 30 includes a grease chamber 35 formed inside the adjustment cylinder 30 and defined by an inner surface of the tube 31 and a front end surface of the piston 34.

The piston 34 includes a rear end side 34b projecting from the tube 31 and is attached to the track frame 6 on the rear end side 34b. The piston 34 includes a grease passage 34c formed inside the piston 34 and penetrating the piston 34 from the rear end side 34b to the front end side 34a. A grease supply and discharge valve 36 is attached to the rear end side 34b, which serves as a supply and discharge port of the grease passage 34c.

The support member 40 is disposed between the idler wheel 10 and the adjustment cylinder 30. The support member 40 generally includes an annular end surface wall 41 into which a front end side 33a of the rod 33 is slidably inserted, a cylindrical peripheral surface wall 42 extending forward from an outer peripheral edge of the annular end surface wall 41, an annular spring bearing portion 43 projecting radially outward from an outer peripheral surface of the peripheral surface wall 42 and extending in a circumferential direction, a lateral pair of projecting portions 44 projecting laterally outward from an outer peripheral edge of the spring bearing portion 43 and shaped like a rectangle, and a lateral pair of support portions 45 extending forward from the projecting portions 44. The support member 40 is positioned so that an axial direction of the annular end surface wall 41 coincides with an axial direction of the rod 33.

The idler wheel 10 is disposed between the support portions 45. The support member 40 axially supports the idler wheel 10 in each of the support portions 45 so that the idler wheel 10 is rotatable. Furthermore, the support member 40 is held in each of the support portions 45 by a support portion guide (not shown in the drawings) disposed on the track frame 6, so as to be movable in the front-rear direction.

The coil spring 20 is positioned on an outer peripheral side of the tube 31 and rod 33 of the adjustment cylinder 30 and disposed such that axial ends of the coil spring 20 are in abutting contact with the flange 32 of the adjustment cylinder 30 and the spring bearing portion 43 of the support member 40. Furthermore, the coil spring 20 is compressed between the flange 23 and the spring bearing portion 43 by a predetermined amount to store a predetermined amount of bias force in the coil spring 20.

The annular end surface wall 41 of the support member 40 has an inner periphery 41a formed to have a size slightly larger than the external size of the rod 33 of the adjustment cylinder 30. The front end side 33a of the rod 33 is inserted into the annular end surface wall 41 along the inner periphery 41a to couple the adjustment cylinder 30 and the support member 40 together.

However, since the rod 33 is slidably inserted into the inner periphery 41a, the adjustment cylinder 30 and the support member 40 can move relative to each other. Thus, a retaining mechanism is provided on the front end side 33a of the rod 33 to inhibit the rod 33 from slipping out from the inner periphery 41a when the bias force of the coil spring 20 presses the adjustment cylinder 30 and the support member 40 in a direction in which the adjustment cylinder 30 and the support member 40 are separated from each other.

The retaining mechanism includes a recess portion 33b formed in an outer peripheral surface of the front end side 33a of the rod 33, a pair of retaining plates 51 disposed in the recess portion 33b, and retaining rings 52 each installed at an outer periphery of the corresponding one of the retaining plates 51.

The recess portion 33b is shaped like a ring and extends in the circumferential direction along the outer peripheral surface of the rod 33 in an area positioned on the front end side 33a of the rod 33 and on an inner surface 41b side of the annular end surface wall 41. Furthermore, the recess portion 33b has a circumferential cross section shaped like a rectangle.

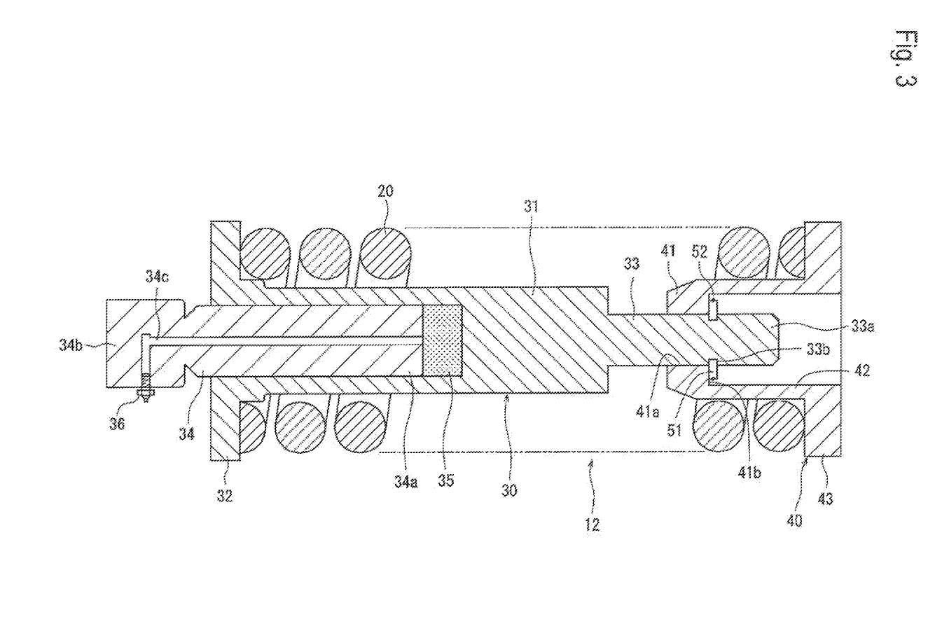

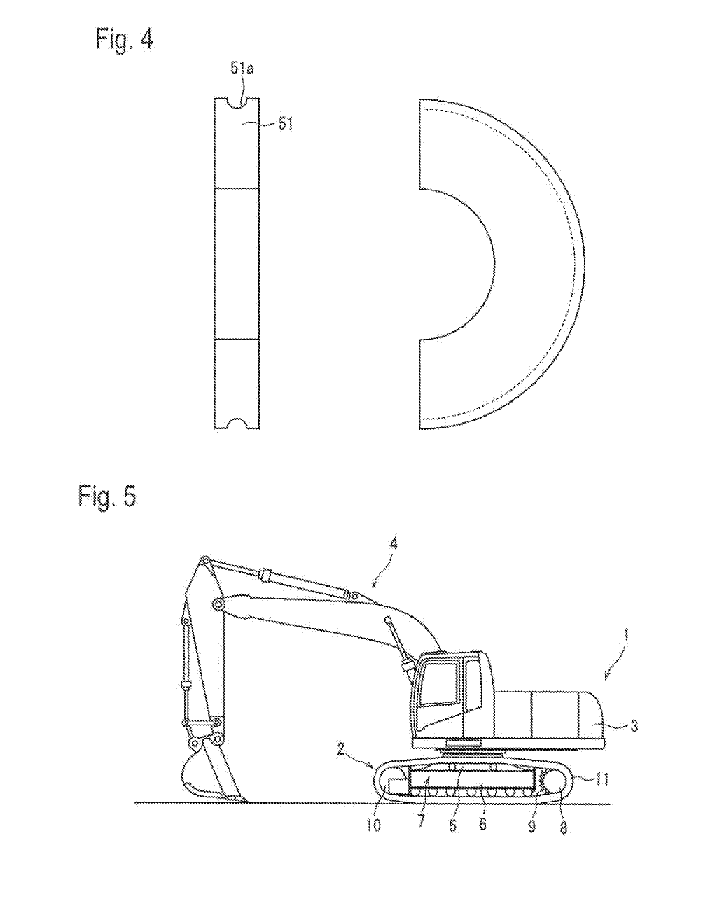

Description will be given with reference to FIG. 4 along with FIG. 3. Each of the retaining plates 51 includes a pair of two semi-annular plate members into which a plate material shaped like a ring is divided, as seen in an axial direction. Each of the retaining plates 51 is disposed in the recess portion 33b so that the pair of semi-annular plate members is shaped like a ring. Furthermore, each of the retaining plates 51 projects radially outward from the rod 33 and extends in a circumferential direction along the outer peripheral surface of the rod 33. Each of the retaining plates 51 has a circumferential cross section shaped like a rectangle.

Each of the retaining plates 51 includes, in the outer peripheral surface thereof, an annular groove 51a having a circumferential cross section shaped like a semi-circle. A C-shaped retaining ring 52 commonly used for a shaft is installed in the annular groove 51a to fix the retaining plates 51 in the recess portion 33b.

Each of the retaining plates 51 and the inner surface 41b of the annular end surface wall 41 are in abutting contact with each other to inhibit the rod 33 from slipping out from the inner periphery 41a of the annular end surface wall 41.

Description will be given which relates to a function to adjust tension of the crawler 11 which function is provided in the shock absorber 12 for the crawler. When grease is fed from a supply and discharge valve 36 to a grease chamber 35 via a grease passage 34c, the piston 34 performs an extending operation relative to the tube 31. However, since the rear end side 34b of the piston 34 is fixed to the track frame 6, the piston 34 actually does not move but the tube 31 moves forward. Then, the coil spring 20 in abutting contact with the flange 32 of the adjustment cylinder 30 is compressed to increase the bias force of the coil spring 20. Thus, the support member 40 in abutting contact with the coil spring 20 in the spring bearing portion 43 is pressed by the coil spring 20 to move forward. As a result, the idler wheel 10 moves forward in conjunction with the support member 40 to tense the crawler 11. On the other hand, when the grease is discharged from the grease chamber 35 via the supply and discharge valve 36, the crawler 11 is loosened.

The effects of the shock absorber 12 for the crawler as described above and shown in FIGS. 1 to 5 will be described.

In the shock absorber 12 for the crawler configured according to the present invention, when the crawler 11 is shocked, the support member 40, which axially supports the idler wheel 10, moves from the front side toward the rear side along with the idler wheel 10. Then, the coil spring 20 is compressed because the coil spring 20 is in abutting contact with the spring bearing portion 43 of the support member 40 at a front end portion of the coil spring 20, and is restrained by the flange 32 of the adjustment cylinder 30 from moving in the front-rear direction, the flange 32 of the adjustment cylinder 30 being in abutting contact with a rear end portion of the coil spring 20. Thus, the shock applied to the crawler 11 is absorbed. After the shock is absorbed, the coil spring 20 extends to move the support member 40 from the rear side toward the front side so as to return to the original position where the coil spring 20 is located before being shocked. However, the coupling with the adjustment cylinder 30 is held by the retaining mechanism.

Even when a heavy load acts repeatedly on the retaining mechanism for the adjustment cylinder 30 and the support member 40 if, for example, the hydraulic excavator 1 is driven and operated on an irregular ground, the load is received by a surface of each of the retaining plates 51 and a surface of the recess portion 33b. This enables a reduction in stress generated on the surface of each of the retaining plates 51 and the surface of the recess portion 33b compared to the stress generated in the threaded portions of the retaining mechanism in the conventional shock absorber for the crawler. Thus, the retaining mechanism according to the present invention can be prevented from being broken.

Furthermore, the recess portion 33b can be formed in a predetermined position in the rod 33 before the shock absorber 12 for the crawler is mounted on the hydraulic excavator 1. This allows suppression of a variation in the position where each of the retaining plates 51 is disposed in the front-rear direction. Hence, the bias force of the coil spring 20 can be easily set within a predetermined range when an operator mounts the shock absorber 12 for the crawler on the hydraulic excavator 1 and compresses the coil spring 20 by a predetermined amount to store a predetermined amount of bias force in the coil spring 20.

Moreover, the retaining mechanism according to the present invention needs a smaller number of components than the conventional retaining mechanism. This allows management of the components to be facilitated and enables a reduction in costs.

### EXPLANATION OF REFERENCE NUMERALS

9 Drive wheel
10 Idler wheel
11 Crawler
12 Shock absorber for crawler
20 Coil spring
30 Adjustment cylinder
31 Tube
32 Flange
33 Rod
33a Front end side
33b Recess portion
40 Support member
41 Annular end surface wall
41a Inner periphery
41b Inner surface
42 Peripheral surface wall
43 Spring bearing portion
51 Retaining plate
51a Annular groove
52 Retaining ring

1-7. (canceled)

8. A shock absorber for a crawler, comprising:
a coil spring configured to bias an idler wheel relative to a frame of the crawler;
an adjustment cylinder configured to adjust a bias force of the coil spring, the adjustment cylinder including a flange projecting radially outward;
a support member disposed circumferentially around at least a portion of the adjustment cylinder, the support member including a spring bearing portion projecting radially outward; and
a retaining plate projecting radially from the adjustment cylinder, the retaining plate configured to prevent axial separation of the adjustment cylinder and the support member,
wherein the coil spring is positioned on an outer peripheral side of the adjustment cylinder and the support member and disposed in abutting contact with the flange and the spring bearing portion.

9. The shock absorber of claim 8, wherein the adjustment cylinder includes:
a tube extending from a front end to a rear end; and
a rod extending forward from the front end of the tube,
wherein the flange is disposed adjacent the rear end, projects radially outward from an outer surface of the tube, and extends in a circumferential direction.

10. The shock absorber of claim 9, wherein the support member includes:
an annular end surface wall configured to slidably receive the rod; and
a peripheral surface wall extending forward from an outer peripheral edge of the annular end surface wall,
wherein the spring bearing portion is disposed nearer the front end of the tube relative to the rear end, projects radially outward from an outer surface of the peripheral surface wall, and extends in the circumferential direction.

11. The shock absorber of claim 10, wherein the rod includes a recess portion in an outer surface of the rod, wherein
the recess portion is disposed adjacent the front end of the tube, and
the retaining plate is disposed in the recess portion.

12. The shock absorber for the crawler according to claim 11, wherein
the retaining plate includes an annular groove formed on an outer surface of the retaining plate, and
a retaining ring is disposed in the annular groove such that the retaining plate is fixed in the recess portion by the retaining ring.

13. The shock absorber for the crawler according to claim 11, wherein the recess portion extends in the circumferential direction along an outer surface of the rod.

14. The shock absorber for the crawler according to claim 11, wherein the recess portion is shaped like a ring.

15. The shock absorber of claim 10, wherein the retaining plate and an inner surface of the annular end surface wall are configured to be in abutting contact with each other.

16. The shock absorber for the crawler according to claim 9, wherein the retaining plate extends in the circumferential direction along an outer surface of the rod.

17. The shock absorber for the crawler according to claim 8, wherein the retaining plate is shaped like a ring.

18. The shock absorber for the crawler according to claim 8, wherein the retaining plate is formed of at least two semi-annular plate members.

19. A machine, comprising:
a lower body;
an upper body mounted on the lower body;
a track frame extending laterally from the lower body;
a drive wheel disposed on a rear-end side of the track frame;
an idler wheel disposed on a front-end side of the track frame opposite the rear-end side;
an endless crawler wound around the drive wheel and the idler wheel; and
a shock absorber disposed between the track frame and the idler wheel, the shock absorber including:
a coil spring configured to bias an idler wheel relative to the track frame;
an adjustment cylinder configured to adjust a bias force of the coil spring, the adjustment cylinder including a flange projecting radially outward;
a support member disposed circumferentially around at least a portion of the adjustment cylinder, the support member being configured to axially support the idler wheel, the support member including a spring bearing portion projecting radially outward; and
a retaining plate projecting radially from the adjustment cylinder, the retaining plate configured to prevent axial separation of the adjustment cylinder and the support member,
wherein the coil spring is positioned on an outer peripheral side of the adjustment cylinder and the support member and disposed in abutting contact with the flange and the spring bearing portion.

20. The machine of claim 19, wherein the adjustment cylinder includes:
a tube extending from a front end to a rear end; and
a rod extending forward from the front end of the tube,
wherein the flange is disposed adjacent the rear end, projects radially outward from an outer surface of the tube, and extends in a circumferential direction.

21. The machine of claim 20, wherein the support member includes:
an annular end surface wall configured to slidably receive the rod; and
a peripheral surface wall extending forward from an outer peripheral edge of the annular end surface wall,
wherein the spring bearing portion is disposed nearer the front end of the tube relative to the rear end, projects radially outward from an outer surface of the peripheral surface wall, and extends in the circumferential direction.

22. The machine of claim 21, wherein the rod includes a recess portion in an outer surface of the rod, wherein
the recess portion is disposed adjacent the front end of the tube, and
the retaining plate is disposed in the recess portion.

23. The machine according to claim 22, wherein
the retaining plate includes an annular groove formed on an outer surface of the retaining plate, and
a retaining ring is disposed in the annular groove such that the retaining plate is fixed in the recess portion by the retaining ring.

24. The machine according to claim 22, wherein the recess portion extends in the circumferential direction along an outer surface of the rod.

25. The machine according to claim 22, wherein the recess portion is shaped like a ring.

26. The machine according to claim 21, wherein the retaining plate and an inner surface of the annular end surface wall are configured to be in abutting contact with each other.

27. The machine according to claim 20, wherein the retaining plate extends in the circumferential direction along an outer surface of the rod.
